(19) United States
(12) Patent Application Publication
(10) Pub. No.: US 2026/0302635 A1
(43) Pub. Date: Oct. 1, 2026

(54) BASE STATION ANTENNAS HAVING METAMATERIAL RF LENSES AND RELATED METAMATERIAL RF LENSES

(71) Applicant: Outdoor Wireless Networks LLC, Richardson, TX (US)

(72) Inventors: Jimmy Ho, Hickory, NC (US); Raghuvaran D, Chennai (IN); Desigan Prabaharan, Chennai (IN); Lance Darren Bamford, Pittsford, NY (US)

(21) Appl. No.: 19/576,539

(22) Filed: Mar. 24, 2026

Related U.S. Application Data
(60) Provisional application No. 63/812,936, filed on May 28, 2025.

(30) Foreign Application Priority Data
Mar. 25, 2025 (IN) 202541027796

(51) Int. Cl. H01Q 15/06; H01Q 15/08; H01Q 19/10

(52) U.S. Cl. CPC H01Q 15/06; H01Q 15/08; H01Q 19/10

(57) ABSTRACT

An RF lens comprises a dielectric substrate, a central lens element on the dielectric substrate, the central lens element comprising a first plurality of conductive elements on the dielectric substrate that are arranged to surround a central region, and a plurality of satellite lens elements that surround the central lens element when the RF lens is viewed from the front, each satellite lens element comprising a respective second plurality of conductive elements on the dielectric substrate.

### CROSS-REFERENCE TO RELATED APPLICATIONS

The present application claims priority to U.S. Provisional Patent Application Ser. No. 63/812,936, filed May 28, 2025 and to Indian Patent Application No. 202541027796, filed Mar. 25, 2025, the entire content of each of which is incorporated herein by reference.

### FIELD

The present invention generally relates to radio communications and, more particularly, to base station antennas utilized in cellular and other communications systems and radio frequency (“RF”) lenses that are suitable for use in such antennas.

### BACKGROUND

Cellular communications systems are well known in the art. In a typical cellular communications system, a geographic area is divided into a series of regions that are referred to as “cells,” and each cell is served by a base station. The base station may include baseband equipment, radios and one or more base station antennas that are configured to provide two-way RF communications with subscribers that are positioned throughout the cell. Most cells are divided into a plurality of “sectors,” and separate base station antennas provide coverage to each of the sectors.

In many applications, a base station antenna includes one or more phase-controlled arrays of dual-polarized radiating elements, with the radiating elements arranged in one or more columns when the antenna is mounted for use. A dual-polarized radiating element is a radiating element that includes a first radiator that transmits and receives RF energy at a first polarization and a second radiator that transmits and receives RF energy at a second polarization that is orthogonal to the first polarization. Each column of radiating elements is coupled to a pair of ports of a radio. RF signals received from the first radio port are split into a plurality of sub-components and fed to the first polarization radiators of the radiating elements in the column. The first polarization radiators radiate the sub-components of the RF signal into free space, generating a first radiation pattern or “antenna beam.” Similarly, RF signals received from the second radio port are split into a plurality of sub-components and fed to the second polarization radiators of the radiating elements in the column, thereby generating a second antenna beam. The phases of the sub-components of the RF signals that are fed to the different radiating elements in a column may be set (e.g., by the length of the RF transmission lines that feed the sub-components to the respective radiating elements) so that the RF energy radiated by the different radiating elements constructively combine to narrow the beamwidth of the antenna beam in the column direction. Narrower antenna beams concentrate the RF energy into a smaller area, thereby increasing the gain of the antenna beam. The above-described columns of radiating elements are typically referred to as “linear arrays” of radiating elements.

Base station antennas including multi-column arrays of radiating elements have also been widely deployed. In some applications, a single RF signal may be sub-divided into a plurality of sub-components and fed to the radiating elements in the multi-column array. The phases of the sub-components of the RF signals that are fed to the radiating elements may be set to narrow the beamwidth of the generated antenna beam, and since multiple rows and columns of radiating elements are provided, the beamwidth may be narrowed in two dimensions, which further increases the gain of the antenna beam. Multi-column arrays of radiating elements are also used in passive and active beamforming applications.

The shape of each antenna beam generated by an array of radiating elements is defined by, among other things, the characteristics of the individual radiating elements, the characteristics of the array (e.g., whether the array is a single radiating element, a column of radiating elements or a two-dimensional array of radiating elements and the spacing between adjacent radiating elements) and by the magnitudes and phases of the sub-components of the RF signal that are fed to each individual radiating element in the linear array. Antenna beams are often characterized by their Half Power Beam Width (“HPBW”). The HPBW refers to the number of degrees, in a designated plane such as the azimuth or elevation planes that are described herein, where the radiated power of a main lobe of the antenna beam is within 3 dB (50%) of the peak power of the antenna beam.

Cellular communications are primarily performed in three different frequency ranges, which are commonly referred to as the “low-band,” “mid-band” and “high-band” frequency ranges. The low-band frequency range is generally defined as the 696-960 MHz frequency range (or more recently as the 617-960 MHz frequency range). The mid-band frequency range is generally defined as the 1695-2690 MHz frequency range (or, more recently as the 1427-2690 MHz frequency range). The high-band frequency range is more variable in nature, but may include different ranges of frequencies in the 3.1-5.8 GHz frequency range. Cellular operators are licensed to use small sub-bands in each of these frequency ranges, where the sub-bands will vary with geographic location and operator.

One common base station configuration is the so-called “three sector” configuration in which a cell is divided into three 120° sectors in the “azimuth” plane, which refers to a horizontal plane that bisects the base station antenna that is parallel to the plane defined by the horizon. A three-sector base station includes three base station antennas that provide coverage to the three respective sectors. In a three sector configuration, the antenna beams generated by each base station antenna typically have a HPBW in the azimuth plane of about 60°-65°, as such an antenna beam may provide good coverage throughout a 120° sector without having significant RF energy spill over into the other two sectors. The linear arrays of radiating elements in such base station antennas generate antenna beams that have beamwidths in the “elevation” plane that are significantly less than 65°. The elevation plane refers to a plane that is perpendicular to the azimuth plane that bisects the front surface of the base station antenna.

There is significant interest in three-sector base station antennas that include two or more linear arrays of radiating elements that support service in the same frequency band, since such base station antennas can support multi-input-multi-output (“MIMO”) communications techniques. When MIMO techniques are used, a baseband data stream is sub-divided into multiple sub-streams that are used to generate respective RF signals that are separately transmitted by the base station antenna. These RF signals are transmitted by spatially separated arrays and/or at orthogonal polarizations so that the transmitted RF signals will be sufficiently decorrelated. The multiple RF signals are recovered at the receiver and demodulated and decoded to recover the original data sub-streams, which are then recombined. The use of MIMO transmission techniques may be very effective in overcoming the negative effects of multipath fading, and hence may increase capacity. While a single array of dual-polarized radiating elements may be used to support 2×MIMO communications (i.e., MIMO with two sub-streams), two arrays of dual-polarized radiating elements are needed to support 4×MIMO communications. Unfortunately, it can be challenging to implement base station antennas that have two or more arrays of low-band radiating elements in a commercially acceptable manner because of the large size of conventional low-band radiating elements.

Base station antennas are also widely deployed that are designed to support cellular communications in stadiums and other large venues such as concert halls, convention centers, outdoor amphitheaters and the like. Supporting cellular communications in such venues may be particularly challenging because large numbers of users are present in the venue during events, and hence a cellular communications system may need to support very high levels of capacity within the venue. In order to support cellular service in such venues, so-called “stadium” base station antennas have been deployed that generate generally rectangular antenna beams. These antennas can be mounted on the ceilings or high on the walls of the venue and pointed to provide coverage to different sections of the stadium. Rectangularly-shaped antenna beams preferably have main lobes that have a relatively constant power level for the desired coverage area and the power level of the antenna beam falls off quickly at the edge of the desired coverage area. This reduces interference between the base station antennas providing coverage to adjacent sectors. It may be difficult, however, to generate such rectangularly shaped antenna beams. As such, conventional stadium antennas often include multi-column arrays of radiating elements that increase the size and cost of the antenna.

RF lenses are known in the art, and may be used to narrow the beamwidths of the antenna beams generated by a base station antenna, thereby increasing the gain of the antenna beams. RF lenses conventionally have been formed using dielectric materials such as polyethylene, and often used a combination of dielectric materials having different relative permittivities to achieve a desired focusing effect. Unfortunately, the size, weight and/or cost of such dielectric lenses is often prohibitive if substantial narrowing of the antenna beams is required. The use of metamaterial RF lenses has also been suggested. Metamaterials, which are also called artificial dielectric materials, refer to a class of materials that have properties that are not usually found in naturally occurring materials, such as a negative refractive index. Metamaterial RF lenses typically comprise a plurality of conductive elements that are small in terms of the wavelengths of the RF energy that is to be focused (e.g., the largest dimension of each conductive element is less than half the smallest a wavelength of the RF energy that is to be focused, and often less than one-tenth of the smallest wavelength). For example, U.S. Patent Publication No. 2024/0347922 (“the '922 publication”) discloses various metamaterial RF lenses that are suitable for use in base station antennas. The entire content of the '922 publication is incorporated herein by reference as if set forth fully herein.

FIG. 1A is a schematic front view of a metamaterial RF lens 1 that is disclosed in the '922 publication. As shown in FIG. 1A, the metamaterial RF lens 1 may be formed on a lamina 10 such as a fiberglass or glass epoxy laminate. A plurality of conductive scattering elements 20 are formed on the lamina 10 and extend radially outward from a central point 32 so that the conductive scattering elements 20 are arranged in a plurality of concentric circles. The material of the lamina 10 may be removed in a central region 34 that is within the smallest of the concentric circles of conductive scattering elements 20. FIG. 1B is a schematic perspective view of another metamaterial RF lens 1′ that is disclosed in the '922 publication. As can be seen, the metamaterial RF lens 1′ comprises two of the metamaterial RF lenses 1 that are stacked front-to-back.

### SUMMARY

Pursuant to embodiments of the present invention, RF lens are provided that comprise a dielectric substrate; a central lens element on the dielectric substrate, the central lens element comprising a first plurality of conductive elements on the dielectric substrate that are arranged to surround a central region; and a plurality of satellite lens elements that surround the central lens element when the RF lens is viewed from the front, each satellite lens element comprising a respective second plurality of conductive elements on the dielectric substrate.

In some embodiments, an opening extends through the dielectric substrate in the central region.

In some embodiments, the first plurality of conductive elements are arranged in concentric circles that extend around the central region.

In some embodiments, the satellite lens elements are radially arranged around the central lens element when the RF lens is viewed from the front.

In some embodiments, the first plurality of conductive elements are arranged in a first pattern and at least one of the second plurality of conductive elements is arranged in a second pattern, where the second pattern matches at least a portion of the first pattern.

In some embodiments, a number of satellite lens elements that surround the central lens element is four, six or eight.

In some embodiments, each satellite lens element is smaller than the central lens element.

In some embodiments, a plurality of satellite openings extend through the dielectric substrate, the satellite openings positioned in between the central lens element and the plurality of satellite lens elements.

In some embodiments, a plurality of the above-described RF lenses may be provided and stacked in a front-to-back direction to provide a multi-layer RF lens.

In some embodiments, each satellite lens element has a truncated circular shape when viewed from the front.

In some embodiments, the first plurality of conductive elements are arranged in concentric rectangles that extend around the central region.

In some embodiments, the above-described RF lenses may be provided in combination with an antenna that includes a reflector and a radiating element that extends forwardly from the reflector, and the RF lens may be positioned forwardly of the radiating element and configured to receive RF energy emitted by the radiating element.

Pursuant to embodiments of the present invention, RF lens are provided that comprise a dielectric substrate; a central lens element on the dielectric substrate, the central lens element comprising a first plurality of conductive elements on the dielectric substrate that extend outwardly from an opening through the dielectric substrate; and a plurality of satellite lens elements that surround the central lens element when the RF lens is viewed from the front, each satellite lens element comprising a respective second plurality of conductive elements on the dielectric substrate.

In some embodiments, the first plurality of conductive elements are arranged in concentric circles that extend around the central region.

In some embodiments, the first plurality of conductive elements are arranged in a first pattern and each second plurality of conductive elements are arranged in a respective second pattern, where each second pattern matches at least a portion of the first pattern.

In some embodiments, a number of satellite lens elements that surround the central lens element is four, six or eight.

In some embodiments, each satellite lens element is smaller than the central lens element.

In some embodiments, a plurality of satellite openings extend through the dielectric substrate, the satellite openings positioned in between the central lens element and the plurality of satellite lens elements.

In some embodiments, each satellite lens element has a truncated circular shape when viewed from the front.

In some embodiments, the above-described RF lenses may be provided in combination with an antenna that includes a reflector and a radiating element that extends forwardly from the reflector, and the RF lens may be positioned forwardly of the radiating element and configured to receive RF energy emitted by the radiating element.

In some embodiments, a plurality of the above-described RF lenses may be provided and stacked in a front-to-back direction to provide a multi-layer RF lens.

Pursuant to embodiments of the present invention, RF lens are provided that comprise a dielectric substrate; a central lens element on the dielectric substrate, the central lens element comprising a first plurality of conductive elements on the dielectric substrate; a plurality of openings that extend through the dielectric substrate; and a plurality of satellite lens elements that surround the central lens element when the RF lens is viewed from the front, each satellite lens element comprising a respective second plurality of conductive elements on the dielectric substrate. The openings are positioned in between the central lens element and the plurality of satellite lens elements.

In some embodiments, a central opening extends through the dielectric substrate in the middle of the central lens element.

In some embodiments, the first plurality of conductive elements surround the central opening.

In some embodiments, the central lens element includes a central region, and wherein the first plurality of conductive elements are arranged in concentric circles that extend around the central region.

In some embodiments, the satellite lens elements are radially arranged around the central lens element when the RF lens is viewed from the front.

In some embodiments, the first plurality of conductive elements are arranged in a first pattern and each second plurality of conductive elements are arranged in a respective second pattern, where each second pattern matches at least a portion of the first pattern.

In some embodiments, a number of satellite lens elements that surround the central lens element is four, six or eight.

In some embodiments, each satellite lens element is smaller than the central lens element.

In some embodiments, the above-described RF lenses may be provided in combination with an antenna that includes a reflector and a radiating element that extends forwardly from the reflector, and the RF lens may be positioned forwardly of the radiating element and configured to receive RF energy emitted by the radiating element.

In some embodiments, a plurality of the above-described RF lenses may be provided and stacked in a front-to-back direction to provide a multi-layer RF lens.

Pursuant to embodiments of the present invention, RF lens are provided that comprise a dielectric substrate; a circular central lens element on the dielectric substrate, the circular central lens element comprising a first plurality of conductive elements on the dielectric substrate; and a plurality of satellite lens elements that surround the central lens element when the RF lens is viewed from the front, each satellite lens element comprising a respective second plurality of conductive elements on the dielectric substrate.

In some embodiments, each satellite lens element has a shape that corresponds to at least a portion of a circle.

In some embodiments, each satellite lens element is a semicircular satellite lens element.

In some embodiments, an opening extends through the dielectric substrate in the middle of the circular central lens element.

In some embodiments, the first plurality of conductive elements are arranged to surround a central region.

In some embodiments, the first plurality of conductive elements are arranged in concentric circles that extend around the central region.

In some embodiments, the satellite lens elements are radially arranged around the circular central lens element when the RF lens is viewed from the front.

In some embodiments, the first plurality of conductive elements are arranged in a first pattern and each second plurality of conductive elements are arranged in a respective second pattern, where each second pattern matches at least a portion of the first pattern.

In some embodiments, a number of satellite lens elements that surround the central lens element is four, six or eight.

In some embodiments, each satellite lens element is smaller than the central lens element.

In some embodiments, a plurality of additional openings extend through the dielectric substrate, the additional openings positioned in between the circular central lens element and the plurality of satellite lens elements.

In some embodiments, each satellite lens element has a truncated circular shape when viewed from the front.

In some embodiments, the above-described RF lenses may be provided in combination with an antenna that includes a reflector and a radiating element that extends forwardly from the reflector, and the RF lens may be positioned forwardly of the radiating element and configured to receive RF energy emitted by the radiating element.

### BRIEF DESCRIPTION OF THE DRAWINGS

FIG. 1A is a schematic front view of a metamaterial RF lens that is disclosed in the '922 publication.

FIG. 1B is a schematic shadow perspective view of another metamaterial RF lens that is disclosed in the '922 publication that is formed by stacking two of the metamaterial RF lenses of FIG. 1A.

FIG. 2 is a schematic front view of a metamaterial RF lens according to certain embodiments of the present invention.

FIG. 3A is a schematic front view of a metamaterial RF lens according to further embodiments of the present invention.

FIG. 3B is a schematic front perspective view of a modified version of the metamaterial RF lens of FIG. 3A.

FIG. 4 is a schematic front perspective view of a multi-layer metamaterial RF lens that comprises a plurality of the metamaterial RF lens of FIG. 3B that are stacked on top of each other.

FIG. 5 is a schematic cross-sectional view of a base station antenna that includes a radiating element and the composite metamaterial RF lens of FIG. 4 with a resultant computer simulated radiation pattern superimposed in the figure to show how the composite metamaterial RF lens flattens the generated antenna beam.

FIG. 6 is a graph of (1) an antenna beam generated by an antenna that includes a radiating element and the two-layer metamaterial RF lenses of FIG. 1B and (2) an antenna beam generated by an antenna that includes a radiating element and the multi-layer metamaterial RF lens of FIG. 4.

FIG. 7 is a graph that shows a first set of simulated antenna beams that are generated by a co-located set of conventional base station antennas that illustrates how the 10 dB overlap impacts the number of sectors a base station can serve.

FIG. 8 is a graph that shows a second set of simulated antenna beams that are generated by a co-located set of the base station antennas of FIG. 4.

FIG. 9 is a schematic perspective view of a base station antenna according to embodiments of the present invention.

FIG. 10A is a schematic cross-sectional view of a conventional bi-convex lens and the paths of the rays of RF radiation from a radiation source that are incident on the lens.

FIG. 10B is a schematic cross-sectional view of a conventional planar metamaterial RF lens and the paths of the rays of RF radiation from a radiation source that are incident on the lens.

FIG. 11 is a schematic front view of a conventional base station antenna that includes two linear arrays of low-band radiating elements with the radome removed.

FIG. 12 is a schematic front view of a base station antenna that includes two linear arrays of low-band radiating elements according to embodiments of the present invention with the radome removed.

FIGS. 13 and 14 are schematic front views of metamaterial RF lenses according to further embodiments of the present invention.

### DETAILED DESCRIPTION

Pursuant to embodiments of the present invention, RF lenses are provided that may be incorporated into base station antennas to improve the performance thereof. While RF lenses have been used in base station antennas, most conventional RF lenses for base station antennas are large and/or expensive, which severely limits the applications where such RF lenses can be used. In contrast, the RF lenses according to embodiments of the present invention may be implemented using printed circuit board (or equivalent) technologies and may be small in size and low cost such that they can be used in a wide variety of different cellular communications applications.

The RF lenses according to embodiments of the present invention may comprise metamaterial RF lenses that include a plurality of sub-wavelength conductive (e.g., metal) elements that are configured to form resonant circuits that redirect RF energy that is incident on the RF lens in a desired manner. The metamaterial RF lenses according to embodiments of the present invention may include a plurality of lens elements, where each lens element may comprise a separate metamaterial lens. In some embodiments, the metamaterial RF lenses may comprise a central lens element and a plurality of additional “satellite” lens elements that surround the central lens element. In some embodiments, the central and satellite lens elements may have the same general configuration. In other embodiments, the satellite lens elements may be truncated versions of the central lens element (e.g., half of the central lens element). Still other embodiments are possible.

In some embodiments, the central lens element may comprise a first plurality of conductive elements that are arranged to surround a central region of the central lens. For example, the conductive elements may extend radially outwardly from the central region. In some embodiments, no conductive elements are provided in a central region of the central lens element. In some embodiments, the metamaterial RF lenses according to embodiments of the present invention may be implemented on a printed circuit board. In such embodiments, a dielectric substrate of the printed circuit board may be partially or completely removed in the central region of the central lens element. In some embodiments, a plurality of the metamaterial RF lenses according to embodiments of the present invention may be stacked (e.g., in front of a radiating element or an array of radiating elements) to achieve an enhanced focusing effect.

The metamaterial RF lenses according to embodiments of the present invention may be used in a variety of different applications. As one example, the metamaterial RF lenses according to embodiments of the present invention may be used to narrow the azimuth beamwidth of the antenna beams generated by a pair of side-by-side linear arrays of low-band radiating elements in a base station antenna that is suitable for use in a three-sector base station. The low-band radiating elements used in many three-sector base station antennas that include two low-band linear arrays are often designed to have a reduced size (in terms of the wavelength of the center frequency of the low-band operating frequency range as compared to conventional mid-band and high-band radiating elements) in order to allow the widths of these base station antennas to be reduced. Unfortunately, as the size of the low-band radiating elements is reduced, the azimuth beamwidths (e.g., the 3 dB and 10 dB azimuth beamwidths) of the antenna beams generated by the low-band linear arrays increases, which reduces the amount of RF energy that falls within the 120° sector. The metamaterial RF lenses according to embodiments of the present invention may be mounted in front of the low-band linear arrays and used to narrow the azimuth beamwidths thereof, thereby advantageously increasing the gain and sector power ratio of these arrays. As another example, the metamaterial RF lenses according to embodiments of the present invention may be used in stadium antennas so that each antenna may include a single radiating element or a smaller array of radiating elements while still providing coverage to a relatively small section of the venue.

Embodiments of the present invention will now be discussed in more detail with reference to FIGS. 2-14.

FIG. 2 is a schematic front view of a metamaterial RF lens 100 according to certain embodiments of the present invention.

The metamaterial RF lens 100 includes a dielectric substrate 110 that has first and second opposed major surfaces and a plurality of conductive elements 120 that may be formed, for example, of any suitable metal such as copper. The dielectric substrate 110 may comprise any suitable dielectric material including, for example, fiberglass, glass epoxy laminate, or a wide variety of plastic materials. The conductive elements 120 may be designed to scatter RF radiation within certain frequency ranges and hence may also be referred to herein as conductive scattering elements 120. In the depicted embodiment, each conductive scattering element 120 has a substantially square profile and is in the form of a square metal ring. It will be appreciated that the conductive scattering elements 120 can have profiles having other shapes in other embodiments such as, for example, rectangular shapes (other than square), circular shapes, cross shapes, etc. which may be filled metal structures or may have metal omitted in the interior. In some embodiments, the conductive scattering elements 120 may be arranged in concentric rings, as shown. In some embodiments, the metamaterial RF lens 100 may be implemented using a printed circuit board with the dielectric substrate of the printed circuit board forming the dielectric substrate 110 and a metallization pattern that is provided on at least one side of the printed circuit board forming the conductive elements 120.

As shown in FIG. 2, the metamaterial RF lens 100 includes a plurality of lens elements, including a central lens element 130 and a plurality of satellite lens elements 140-1 through 140-4. It should be noted that herein like elements may be referred to individually by their full reference numeral (e.g., satellite lens 140-2) and may be referred to collectively by the first part of their reference numeral (e.g., the satellite lenses 140). The central lens element 130 comprises a first plurality 122 of conductive scattering elements 120 that extend radially outward from a central region 132. The first plurality 122 of conductive scattering elements 120 of the central lens element 130 thus may be arranged in a plurality of concentric circles 138A, 138B, 138C. The conductive scattering elements 120 have dimensions that are small as compared to wavelengths of the operating frequency band of the radiating elements (discussed below) that are associated with the metamaterial RF lens 100. The central region 132 of the central lens element 130 may not include any conductive scattering elements 120. In some embodiments, the material of the dielectric substrate 110 may be thinned or completely removed in the central region 132 to provide a central aperture 134.

In the depicted embodiment, each satellite lens element 140 is identical to the central lens element 130. Thus, each satellite lens element 140 comprises a respective second plurality 124 of conductive scattering elements 120 that extend radially outward from a central region 142 of the respective satellite lens element 140. The central region 142 of each satellite lens element 140 may be devoid of any conductive scattering elements 120 and, in some embodiments, the material of the dielectric substrate 110 may be thinned or completely removed in the central region 142 to provide a central aperture 144. In other embodiments, each satellite lens element 140 may be different than the central lens element 130. For example, in other embodiments, the satellite lens elements 140 may have differing numbers of conductive scattering elements 120, different numbers of concentric circles of conductive scattering elements 120, conductive scattering elements 120 that arranged on differing radii, etc.

The satellite lens element 140 are arranged to surround the central lens element 130. In the depicted embodiment, a total of four satellite lens element 140 are provided that are radially arranged around the central lens element 130 and radially separated from adjacent satellite lens elements 140 by 90°. In other embodiments, fewer (e.g., three) or more (e.g., six or eight) satellite lens elements 140 may be provided. In each case, the satellite lens elements 140 may be arranged to surround the central lens element 130, although embodiments of the present invention are not limited thereto.

While not shown in FIG. 2, a radiating element may be mounted behind the metamaterial RF lens 100 and may be configured to transmit and/or receive RF radiation through the metamaterial RF lens 100. Typically, the radiating element is mounted directly behind the central region 132 of the central lens element 130. The radiating element may be positioned so that some of the emitted (or received) RF radiation will pass through the central region 132 while other of the emitted (or received) RF radiation will pass through the portion of the central lens element 130 that includes the conductive scattering elements 120 and through the satellite lens elements 140.

As discussed above, the material of the dielectric substrate 110 may be thinned or completely removed in the central region 132 to provide a central aperture 134. In order to keep the depths of the base station antennas according to embodiments of the present invention within suitable dimensions, it may be necessary to position the metamaterial RF lenses that are disclosed herein in close proximity to their associated radiating elements. This may cause unwanted reflections, which may in turn increase the voltage standing wave ratio (“VSWR”) of the radiating elements at some frequencies in the operating frequency range to an undesirable extent. Removing the dielectric material in the central region may reduce the impact that the metamaterial RF lenses may have on the VSWR.

As noted above, the conductive scattering elements 120 may have dimensions substantially smaller than the operating wavelength. The dimensions of the conductive scattering elements 120 are chosen by design such that the phase shift caused to an electromagnetic wave passing through the lens 100 varies as a function of the distance from the center axis of the lens 100. The rate of change of the phase shift with radial distance from the axial direction of the radiating path of the lens 100 determines the effective focal length of the lens 100 and is chosen by design to suit particular applications.

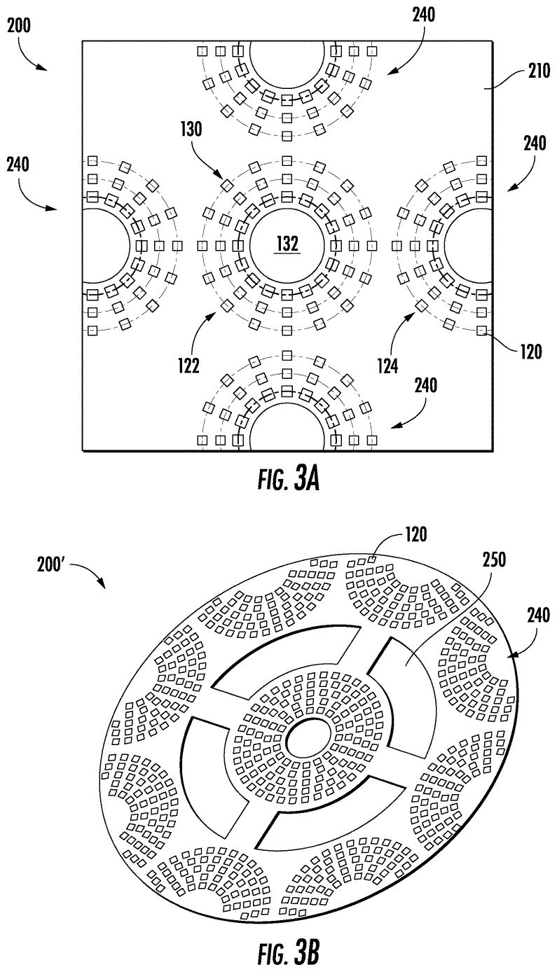

FIG. 3A is a schematic front view of a metamaterial RF lens 200 according to further embodiments of the present invention. The metamaterial RF lens 200 is similar to the metamaterial RF lens 100 and, as such, the description thereof will focus on the differences between the two metamaterial RF lenses 100, 200. Like elements in lenses 100, 200 may be denoted using the same reference numerals, and further description of such elements may be omitted.

As shown in FIG. 3A, metamaterial RF lens 200 includes a central lens element 130 and a plurality of satellite lens elements 240, where each satellite lens element 240 is a truncated version of one of the satellite lens elements 140 of metamaterial RF lens 100. In the depicted embodiment, each satellite lens element 240 comprises approximately one half of one of the satellite lens element 140 of the metamaterial RF lens 100 of FIG. 2 so that each satellite lens element 240 has a substantially semicircular shape when viewed from the front. The truncated the satellite lens elements 240 included in metamaterial RF lens 200 allow the dielectric substrate 210 of metamaterial RF lens 200 to be reduced in size as compared to the dielectric substrate 110 of metamaterial RF lens 100.

FIG. 3B is a schematic front view of a metamaterial RF lens 200′ that is a modified version of the metamaterial RF lens 200 of FIG. 3A. As can be seen by comparing FIGS. 3A and 3B, metamaterial RF lens 200′ differs from metamaterial RF lens 200 in two ways. First, metamaterial RF lens 200′ includes eight satellite lens elements 240 instead of the four satellite lens elements 240 included in metamaterial RF lens 200. In order to make room for eight satellite lens elements 240, the satellite lens elements 240 are positioned farther radially outwardly from the central lens element 130. As with metamaterial RF lens 200 of FIG. 3A, the satellite lens elements 240 are truncated to conform to the circumferences of the respective dielectric substrates on which they are formed. Second, metamaterial RF lens 200′ differs from metamaterial RF lens 200 in that a plurality of additional “satellite” openings 250 are provided where the material of the dielectric substrate 210 has be thinned or completely removed. The satellite openings 250 are positioned in between the central lens element 130 and the satellite lens elements 140. The presence of the satellite openings 250 may decrease the weight of the metamaterial RF lens 200′ and may also reduce or eliminate scattering of the RF radiation that passes through the satellite openings 250. This may improve the performance of the metamaterial RF lens 200′.

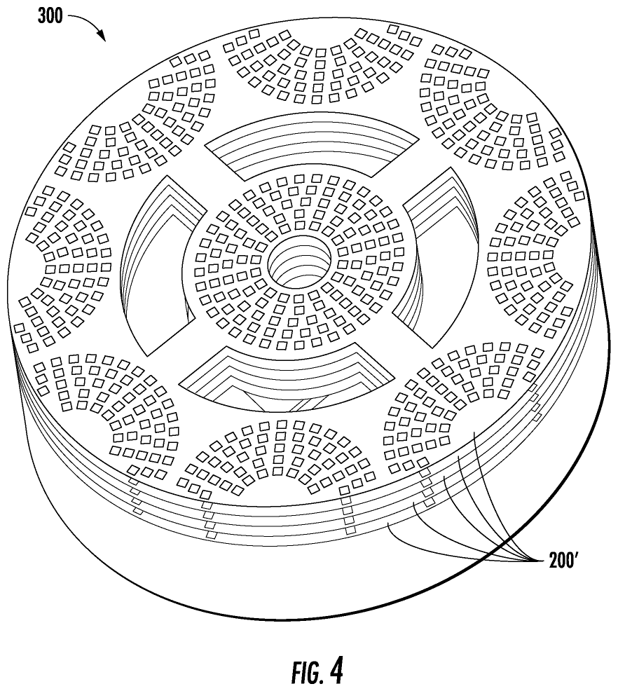

FIG. 4 is a schematic front view of a multi-layer metamaterial lens 300 that comprises a plurality of the metamaterial RF lens 200′ that are stacked on top of each other in a front-to-back direction (and may be aligned along a common axis, as shown). By stacking multiple metamaterial RF lenses 200′ in front of a radiating element, the amount that the emitted RF radiation is focused can be increased, further narrowing the beamwidths of the generated antenna beams. Metamaterial RF lens 300 may be particularly well-suited for use as a stadium antenna. As discussed above, stadium antennas are typically designed to generate antenna beams that have rectangular shapes with fast roll-off at the sector edges. Preferably, the power of the antenna beam is relatively flat within the desired coverage area (sector) and the power levels preferably decrease rapidly at the edges of the desired coverage area to reduce interference between adjacent sectors.

As shown in FIG. 4, in some embodiments, the RF lens 200′ may be provided in combination with a plurality of additional identical RF lenses 200′, where the RF lenses 200′ are stacked in a front-to-back direction. As shown, in some embodiments, a plurality of satellite openings 250 extend through the dielectric substrate 210, the satellite openings 250 may be positioned in between the central lens element 130 and the plurality of satellite lens elements 240.

Referring to FIGS. 2, 3A-3B and 4, pursuant to embodiments of the present invention, RF lenses 100, 200, 200′, 300 are provided that comprise a dielectric substrate 110, 210, a central lens element 130 on the dielectric substrate 110, 210, where the central lens element 130 comprises a first plurality 122 of conductive elements 120 on the dielectric substrate 210 that extend outwardly from a central region 132. The RF lens 100, 200, 200′, 300 further comprises a plurality of satellite lens elements 140, 240 that surround the central lens element 130 when the RF lens is viewed from the front, where each satellite lens element 240 comprises a respective second plurality 124 of conductive elements 120 on the dielectric substrate 210.

Still referring to FIGS. 2, 3A-3B and 4, pursuant to further embodiments of the present invention, RF lenses 100, 200, 200′, 300 are provided that comprise a dielectric substrate 210, a central lens element 130 on the dielectric substrate 110, 210, the central lens element 130 comprising a first plurality 122 of conductive elements 120 on the dielectric substrate 110, 210, and a plurality of satellite lens elements 240 that surround the central lens element 130 when the RF lens is viewed from the front. Each satellite lens element 240 may comprise a respective second plurality 124 of conductive elements 120 on the dielectric substrate 110, 210. A plurality of satellite openings 250 extend through the dielectric substrate 210, the satellite openings 250 positioned in between the central lens element 130 and the plurality of satellite lens elements 240.

Continuing to refer to FIGS. 2, 3A-3B and 4, pursuant to further embodiments of the present invention, RF lenses 100, 200, 200′, 300 are provided that comprise a dielectric substrate 110, 210, a circular central lens element 130 on the dielectric substrate 110, 210, the circular central lens element 130 comprising a first plurality 122 of conductive elements 120 on the dielectric substrate 110, 210, and a plurality of satellite lens elements 240 that surround the central lens element 130 when the RF lens is viewed from the front. Each satellite lens element 240 may comprise a respective second plurality 124 of conductive elements 120 on the dielectric substrate 110, 210. The satellite lens elements 240 may, for example, have shapes that corresponds to at least a portion of a circle.

FIG. 5 is a schematic cross-sectional view of a radiating element 310 and the multi-layer metamaterial RF lens 300 of FIG. 4 with a resultant computer simulated radiation pattern superimposed in the figure to show how the composite metamaterial RF lens 300 flattens the generated antenna beam. As shown in FIG. 5, a cross-dipole radiating element 310 may be mounted on a reflector 320 of a base station antenna. The multi-layer metamaterial RF lens 300 is mounted forwardly of the radiating element 310 The gray-scale regions in FIG. 5 show the simulated wavefronts of the RF radiation emitted by the radiating element 310. As will be understood by one of skill in the art, a dipole radiator will generate RF radiation having a spherical wavefront when excited by an RF signal. When the dipole radiator is mounted above a reflector 320, the generated wavefront will have a semi-spherical shape. As can be seen in FIG. 5, the multi-layer metamaterial RF lens 300 flattens the semi-spherical wavefront and concentrates the RF energy.

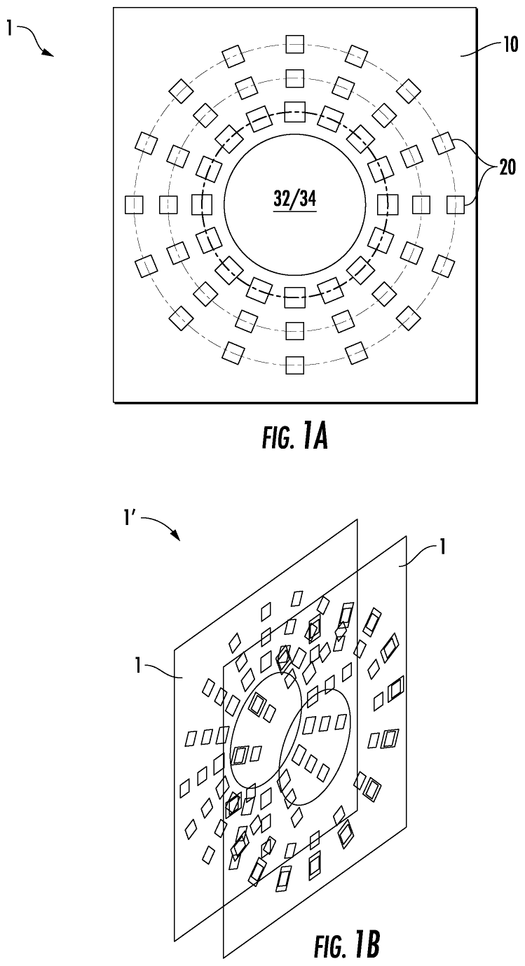

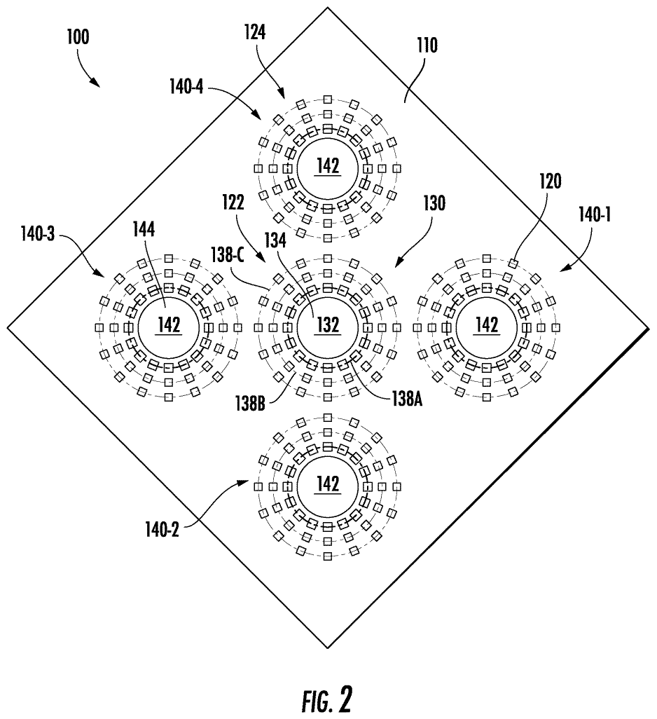

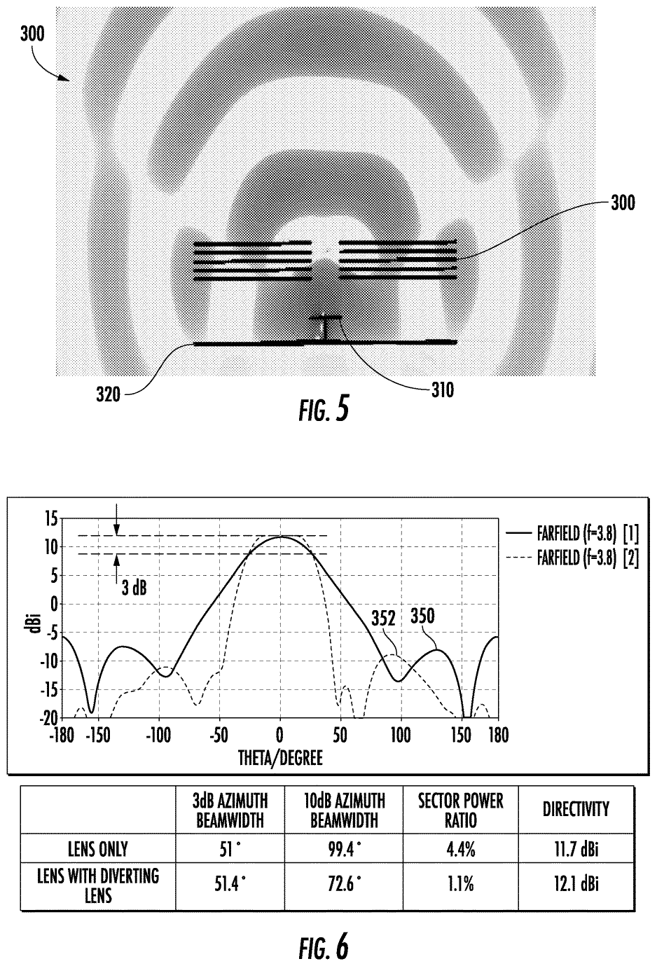

FIG. 6 is a graph of (1) a first antenna beam (curve 350) generated by a first antenna that includes a radiating element 310 and the conventional metamaterial RF lens of FIG. 1B and (2) a second antenna beam (curve 352) generated by a second antenna that includes a radiating element 310 and the metamaterial RF lens 300 of FIG. 4. Note that the conventional metamaterial RF lens used to generate curve 350 only included two layers while the metamaterial RF lens used to generate curve 352 included five layers so that the 3 dB beamwidths on the two lenses would be about the same (about 51°) so that the shapes of the two antenna beams could properly be compared. The horizontal axis in FIG. 6 represents degrees from the boresight pointing direction of the first and second antennas. As shown in FIG. 6, the antenna beams generated by the first and second antennas have similar 3 dB beamwidths. However, the second antenna beam has a main lobe that is much flatter, and falls off much faster at angles outside the 3 dB beamwidth. As a result, the second antenna beam concentrates a greater percentage of the emitted RF radiation with the desired coverage area or “sector,” and has less spillover of RF radiation into adjacent sectors where such spillover RF radiation appears as interference. Both characteristics result in improved performance as compared to the first antenna beam. In addition, the flat power level within the sector means that the quality of service is more consistent throughout the sector, which is also a desirable trait. Note that the beamwidths shown in FIG. 6 are both the azimuth and elevation beamwidths since the antenna beams are generated using a single radiating element that transmits RF radiation through a symmetrical RF lens. As can be seen in FIG. 6, the interaction between the central lens element 130 and the satellite lens elements 240 in the metamaterial RF lens 300 of FIG. 4 broadens the beamwidth, which is why five layers are required to achieve the 51.4° 3 dB beamwidth. This interaction also provides the sharp roll-off.

The table that is included as part of FIG. 6 quantifies various of the performance characteristics of the above-described first and second antennas. As shown in the table, the 3 dB azimuth beamwidths of the antenna beams generated by the two antennas are nearly identical at 51° and 51.4°. The 10 dB beamwidths, however, are quite different, with the first antenna beams having a 10 dB beamwidth of 99.4° while the second antenna beams have a much narrower 10 dB beamwidth of 72.6°. Additionally, the sector power ratio of the antenna beams generated by the second antenna is 1.1% versus 4.4% for the antenna beams generated by the first antenna. As is well understood in the art, the sector power ratio represents the amount of the RF power radiated by an antenna that is outside of a desired coverage area (sector) divided by the total amount of the RF power radiated within the desired coverage area (sector). Thus, smaller sector power ratios are desired as the sector power ratio is a measure of interference. The peak directivity of the second antenna beam is 0.4 dBi higher than the peak directivity of the first antenna beam, which is also a significant improvement.

As described above, the coverage area for a base station of a cellular communications network is often divided into a plurality of sectors, such as the three-sector base stations discussed above. A similar approach is typically used in stadiums and other large venues, where each base station has multiple antennas that are configured to cover respective sectors of the “cell” served by the base station. Since in large venues the antennas are typically ceiling mounted or mounted high on the walls of the venue, a single base station can often be divided into a larger number of sectors, such as four to eight sectors. Cellular network operators typically design the cellular network so that the antenna beams covering adjacent sectors are about 10 dB below peak power at the edges of the sector. Thus, the edges of each sector generally correspond to the region where the antenna beam covering the sector is within 10 dB of the peak directivity of the antenna beam. The antenna beams generated by base station antennas covering side-by-side sectors thus overlap at a location where each antenna beam is about 10 dB below the maximum directivity of the respective antenna beams.

FIG. 7 is a graph that shows a first set of simulated antenna beams that are generated by a co-located set of base station antennas that illustrates how the 10 dB overlap impacts the number of sectors a base station can serve. The simulated antenna beams shown in FIG. 7 are representative of the antenna beams generated by a conventional base station antenna. As shown in FIG. 7, when the antenna beams are arranged to overlap at their 10 dB points, each sector covers about 100°, which follows from the 10 dB beamwidth of 99.4° shown in the table included in FIG. 6. This acts as a restriction on the number of different beam directions that may be generated at a given location, with the base station being able to only cover three sectors in a given plane (e.g., the azimuth plane) or perhaps cover four sectors in undesirable concessions are made regarding the crossover points.

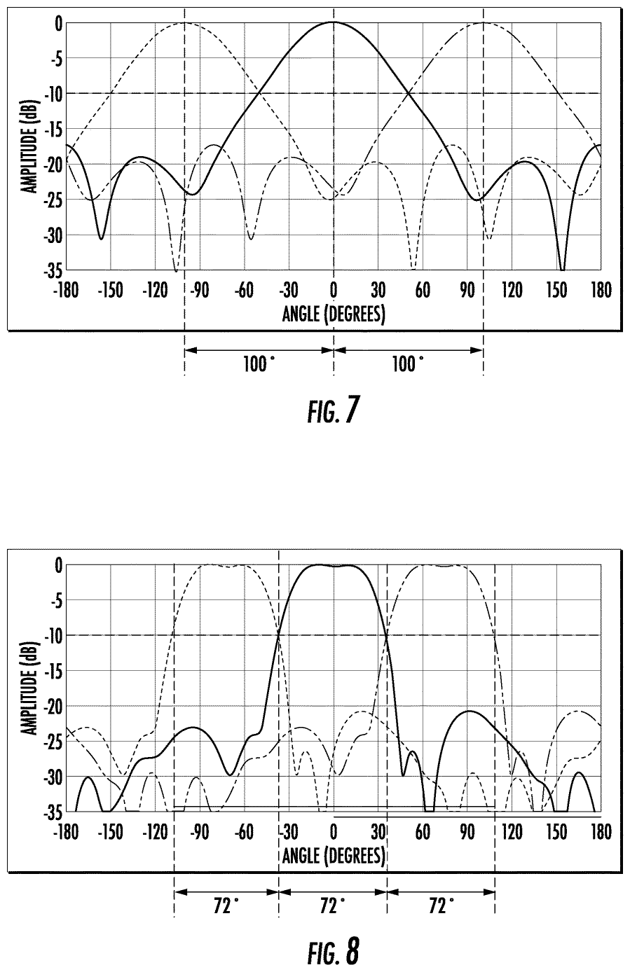

FIG. 8 is a graph that shows a second set of simulated antenna beams that are generated by a co-located set of base station antennas that are formed using radiating elements and the multilayer metamaterial RF lens 300 of FIG. 4. As shown in FIG. 8, when the antenna beams are arranged to overlap at their 10 dB points, each sector covers about 72°, which follows from the 10 dB beamwidth of 72.6° shown in the table included in FIG. 6. As such, a total of five sectors may be served by a given base station in a given plane (e.g., the azimuth plane). This allows a reduction in the total number of base stations, which can result in significant cost savings for cellular network operators.

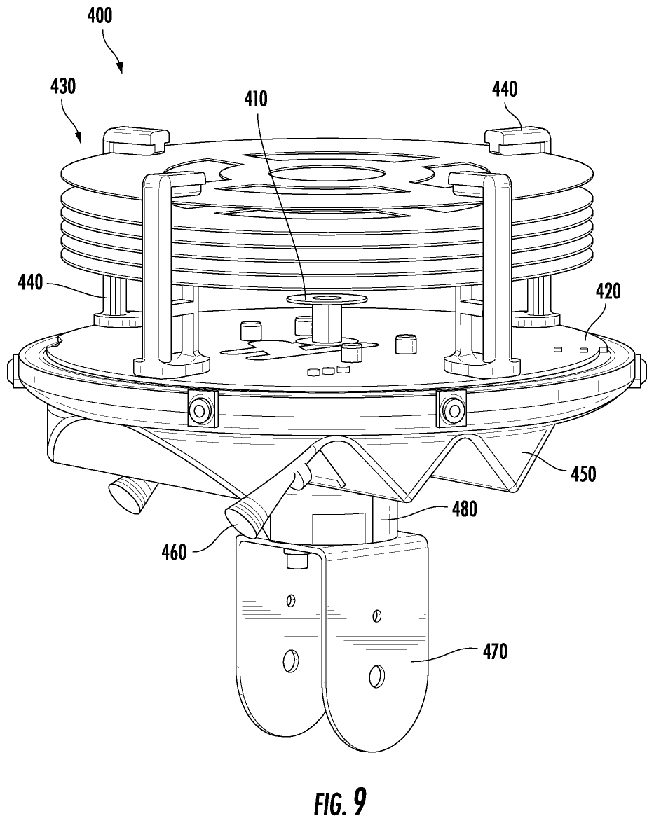

FIG. 9 is a schematic perspective view of an antenna 400 according to embodiments of the present invention. As shown in FIG. 9, the antenna 400 comprises a radiating element 410 that is mounted on a reflector 420 so that the radiating element 410 extends forwardly from the reflector 420. As shown, the radiating element 410 may comprise, for example, a cross-dipole radiating element. It will be appreciated, however, that any type of radiating element may be used including, for example, a single-polarization dipole radiating element, a monopole, a patch radiating element, a horn radiator, etc. It will also be appreciated that the radiating element may have any appropriate polarization or polarizations (e.g., circular, slant linear, horizontal, vertical, etc.). The reflector 420 may comprise, for example, a sheet of metal or a metallized surface on a dielectric layer. The reflector 420 is configured to reflect RF radiation that is emitted backwardly by the dipole radiators of radiating element 410 in the forward direction. A multilayer metamaterial RF lens 430 is mounted forwardly of the radiating element 410.

The multilayer metamaterial RF lens 430 may be any of the metamaterial RF lenses according to embodiments of the present invention. A plurality of lens support members 440, such as plastic support pieces, are provided that position and support the multilayer metamaterial RF lens 430 forwardly of the radiating element 410. The lens support members 440 may also include elements that hold the individual metamaterial RF lens of the multilayer metamaterial RF lens 430 in their proper positions relative to each other and to the radiating element 410. The lens support members 440 may also ensure that the multilayer metamaterial RF lens 430 is properly aligned with respect to the radiating element 410.

Antenna 400 further includes a support member 450. At least one radio frequency connector 460 is supported by support member 450 and is connected to radiating element 410 by means of an RF transmission line (not shown). Support member 450 may be formed of conductive and/or non-conductive materials.

A mounting bracket 470 is connected to support member 450 by way of an adjustable arrangement 480 which together with the mounting bracket 470 provides for the adjustment and maintenance of the direction of the antenna beams generated by antenna 400 in both azimuth and elevation, as well as enabling axial rotation of antenna 400 to adjust the plane of polarization of transmitted and/or received signals. Mounting bracket 470 also supports a radome (not shown) whose function is to protect the antenna from the environment.

In one example embodiment, antenna 400 may be configured to transmit and receive signals in the 3300-4000 MHZ operating frequency band, the dipole radiators of radiating element 410 are supported approximately a quarter-wavelength forwardly of the face of reflector 420, and the distance in the forward direction between the face of the reflector 420 and the forward (distal) face of the multilayer metamaterial RF lens 430 is three-quarters of a wavelength, while the diameter of the multilayer metamaterial RF lens 430 is 3.2 wavelengths. Here, the term “wavelength” refers to the wavelength corresponding to the center frequency of the operating frequency band of antenna 400.

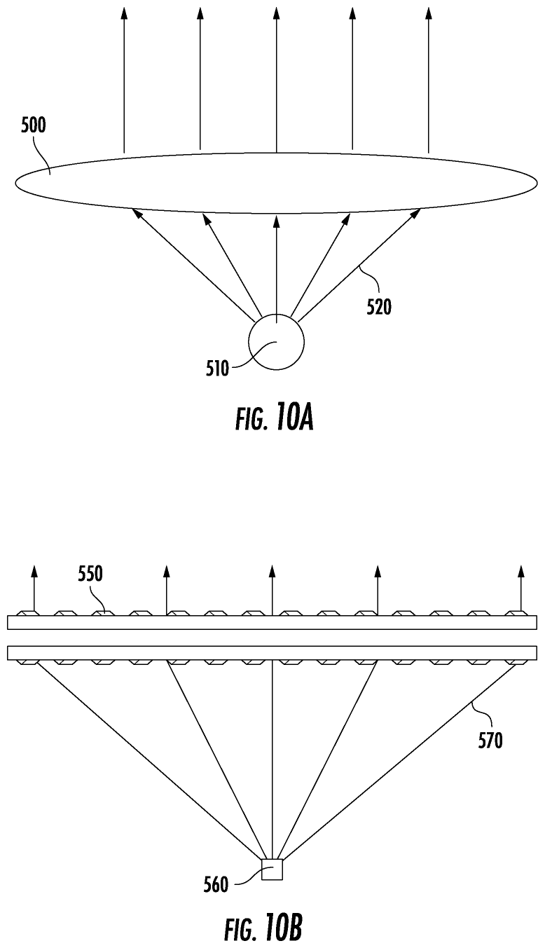

A theory of operation of the metamaterial RF lenses according to embodiments of the present invention will now be discussed and compared and contrasted with the operation of a conventional biconvex lens. FIG. 10A is a schematic cross sectional view of a conventional biconvex lens 500 that receives RF radiation from a radiation source 510. The RF radiation emitted by the radiation source diverges, as shown, and hence enters the biconvex lens 500 along the full width of the lens. The biconvex lens 500 may comprise, for example, a dielectric material. The velocity of propagation of the RF radiation is reduced as is passes through the dielectric lens material. Since the center of the lens 500 is thicker than the edges, the RF radiation that travels through the center of the lens 500 experiences a greater phase shift than the RF radiation that passes through the outer portions of the lens 500. Consequently the “rays” 520 of RF radiation exiting the biconvex lens 500 are parallel to each other, resulting in a more focused antenna beam.

FIG. 10B is a schematic cross sectional view of a conventional planar metamaterial lens 550 that receives RF radiation from a radiation source 560. Once again, the RF radiation emitted by the radiation source diverges, and hence enters the metamaterial lens 550 along the full width of the lens. The metamaterial lens 550 is configured to impose the maximum phase shift to rays entering the center of the lens, and less phase shift is applied to rays entering outer portions of the lens 550. As a result, the “rays” 570 of RF radiation exiting the metamaterial lens 550 are parallel to each other, resulting in a more focused antenna beam.

While the conventional planar metamaterial lens 550 focuses the energy received from the radiation source, 560, it generates antenna beams that have a relatively slow-roll off with respect to angle from boresight, as shown in the graph of FIG. 6. The metamaterial RF lenses according to certain embodiments of the present invention differ from the conventional planar metamaterial lens 550 of FIG. 10B in at least two significant ways. First, the metamaterial RF lenses according to certain embodiments of the present invention may include a central region in the middle of the central lens element where no conductive scattering elements are provided that would otherwise slow down the portions of the RF signal that are transmitted through the central region. In fact, in some embodiments, the material of the dielectric substrate may be partially or completely removed in the central region so that there may not even be any dielectric material slowing down the portions of the RF signal that are transmitted through the central region. Second, the addition of the satellite lens elements 140, 240 that are provided in the metamaterial lenses according to embodiments of the present invention act to push some of the RF energy that would otherwise be directed outside of the sector back into the sector. The net result of these changes is that a very fast roll off can be achieved at the edge of the sector, and the gain within the sector is made more uniform. As discussed above, antenna beams having such characteristics may provide improved performance as the gain within the sector is increased and the interference outside of the sector is reduced.

The metamaterial RF lenses according to embodiments of the present invention may be used, for example, in antennas that are designed to provide coverage to stadiums or other large venues. As explained in U.S. Patent Publication No. 2017/0229785, published Aug. 10, 2017 (herein “the '785 publication”), rectangularly-shaped antenna beams may be well-suited for providing coverage to stadiums and other large venues, particularly when the antennas are mounted above the users (e.g., on the ceiling or high on the walls of the venue) and pointed downwardly (e.g., at an elevation angle of between −25° and −165°) or pointed generally horizontally (sometimes even with an uptilt in the elevation plane) at a portion of a stadium. The stadium antenna disclosed in the '785 publication includes three multi-column arrays that generate antenna beams having half power beamwidths of about 50° in both the azimuth and elevation planes so that the antenna beams have a generally square-shape. As disclosed above, the antennas according to embodiments of the present invention can generate rectangular (e.g., square) antenna beams that provide relatively constant gain within a sector and that have steep roll off so that they have reduced interference with respect to adjacent sectors. Thus, pursuant to some embodiments of the present invention, the antennas disclosed herein may be used in stadiums or other large venues.

It will be appreciated, however, that the metamaterial RF lenses disclosed herein may advantageously be used in a variety of other applications. As an example, one challenge facing base station antenna manufacturers is providing base station antennas that have two linear arrays of low-band radiating elements that have a relatively narrow width. For example, FIG. 11 is a schematic front view of a conventional base station antenna 600 (with the radome thereof removed) that includes two linear arrays of dual-polarized low-band radiating elements. As shown in FIG. 11, base station antenna 600 includes first and second linear arrays 620-1, 620-2 of dual polarization low-band radiating elements 622. The first polarization radiators of each radiating element in the first linear array 620-1 are connected to a first RF port, the second polarization radiators of each radiating element in the first linear array 620-1 are connected to a second RF port, the first polarization radiators of each radiating element in the second linear array 620-2 are connected to a third RF port, the second polarization radiators of each radiating element in the second linear array 620-2 are connected to a fourth RF port. In FIG. 11 the radiating elements are illustrated by “X” shapes to simplify the drawing.

The low-band radiating elements 622 are typically the largest radiating elements in a base station antenna, as the size of a radiating element generally is inversely proportional to its operating frequency band. The two low-band linear arrays 620-1, 620-2 also need to be spaced apart from each other to ensure sufficient isolation between the two arrays 620. This results in the base station antenna 600 typically having a large width, which increases the weight of the antenna 600 and the wind loading thereon. In order to reduce the width of the base station antenna, the low-band radiating elements 622 are often made smaller than optimal. As a result, the azimuth beamwidths of the antenna beams generated by the low-band arrays 620 tend to be larger than is optimal, resulting in reduced gain within the sector served by the base station antenna 600 and increased spillover of RF energy into neighboring sectors, both of which effects are undesirable.

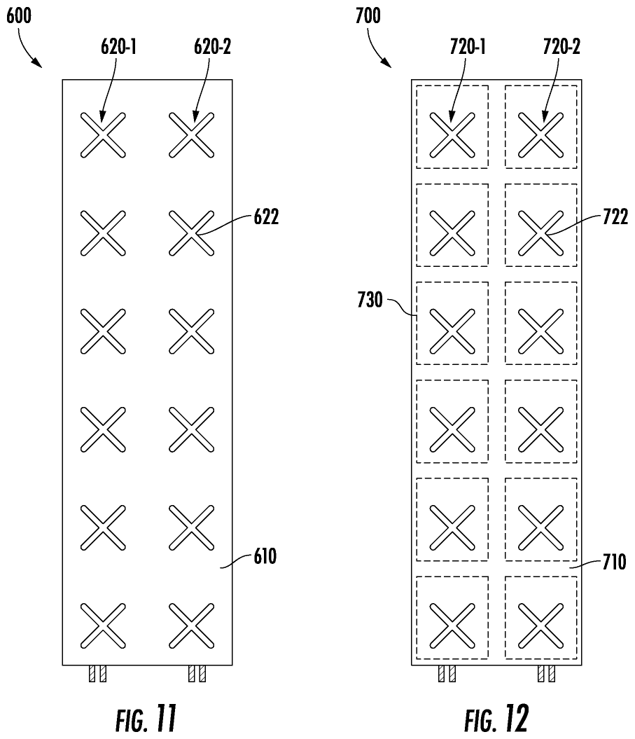

As shown in FIG. 12, pursuant to further embodiments of the present invention, base station antennas are provided that include first and second arrays 720-1, 720-2 of low-band radiating elements 722 and that further include a plurality of the metamaterial RF lenses 730 according to embodiments of the present invention. As shown in FIG. 12, in some embodiments, a metamaterial RF lens 730 may be mounted forwardly of each low-band radiating element 722. The metamaterial RF lens 730 may reduce both the azimuth and elevation beamwidths of the radiation patterns generated by each individual low-band radiating element 722. As a result, the azimuth and elevation beamwidths of the antenna beams generated by the two low-band linear arrays 720 will also be reduced, providing increased gain and reduced interference with neighboring sectors. The narrower antenna beams also result in less interference (i.e., increased isolation) between the two low-band linear arrays 720, and may allow the number of radiating elements 722 included in each low-band array 720 to be reduced while still achieving the same half power beamwidth in the elevation plane as convention base station antenna 600.

While FIG. 12 shows an individual metamaterial RF lenses being mounted in front of every radiating element 722 in each low-band array 720, it will be appreciated that embodiments of the present invention are not limited thereto. For example, in other embodiments, metamaterial RF lenses 730 may only be mounted in front of some of the low band radiating elements 722. It will also be appreciated that larger printed circuit boards may be used so that the metamaterial RF lenses 730 for more than one radiating element 722 are implanted in the same printed circuit board.

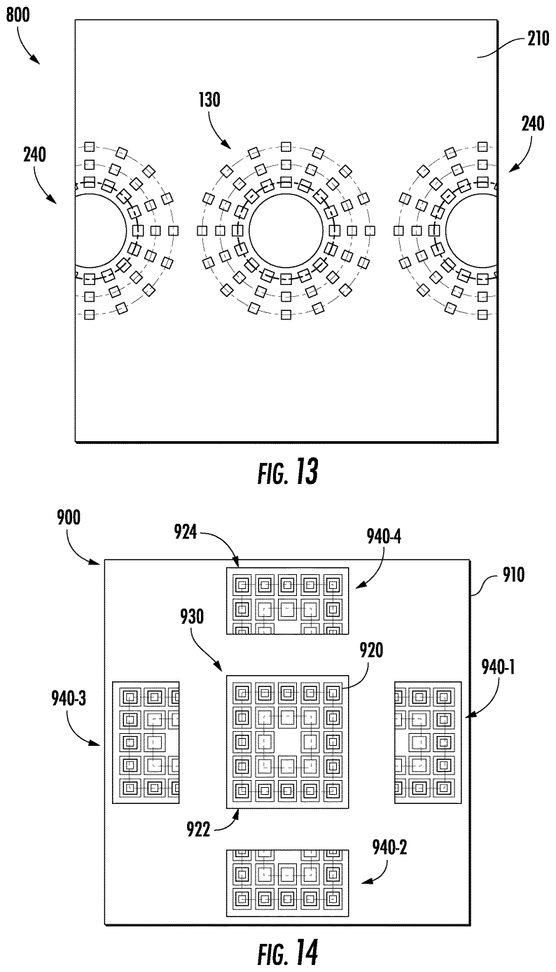

It will also be appreciated that the design of the metamaterial RF lens according to embodiments of the present invention may be modified when the metamaterial RF lenses are used to narrow the beamwidths of the antenna beams generated by linear arrays of radiating elements. For, example, FIG. 13 is a schematic front view of a metamaterial RF lens 800 according to further embodiments of the present invention. The metamaterial RF lens 800 may be identical to metamaterial RF lens 200 of FIG. 3A, except that the upper and lower satellite lens elements 240 are omitted. A plurality of metamaterial RF lenses 800 may be stacked in the front-to-back direction to provide a multi-layer metamaterial RF lens. Omitting the upper and lower satellite lens elements 240 as is done in FIG. 13 may be preferred in some applications since the array factor associated with having a vertical column of radiating elements may be used to narrow the beamwidth in the vertical direction, thereby avoiding the need for the upper and lower satellite lenses 240 (which reduces the size of the lens). This design may also facilitate fitting the metamaterial RF lenses 800 within a base station antenna without the lenses 800 overlapping in the vertical direction.

FIG. 14 is a schematic front view of a metamaterial lens 900 according to further embodiments of the present invention. The metamaterial lens 900 includes a dielectric substrate 910 that has a plurality of conductive (metal) scattering elements 920 thereon. The metamaterial RF lens 900 includes a plurality of lens elements, including a central lens element 930 and a plurality of satellite lens elements 940-1 through 940-4. The central lens element 930 comprises a first plurality 922 of conductive scattering elements 920 that surround a central region 932, while each satellite lens element 940 comprises a second plurality 924 of conductive scattering elements 920 that surround respective central regions 942 of the satellite lens elements 940. Metamaterial lens 900 is similar to metamaterial lens 200, but differs from metamaterial lens 200 in that (1) it includes conductive scattering elements 920 that each have a concentric square ring shape and (2) the conductive scattering elements 920 are arranged in concentric square metal rings as opposed to a single square metal ring. As metamaterial lens 900 may otherwise have the same design as metamaterial lens 200, further description thereof will be omitted here. The use of conductive scattering elements 920 that each include multiple concentric rings may increase the focusing effect. Conductive scattering elements that include two or more concentric rings may be used in any of the embodiments described herein, and the rings may have any shape (square, circular, polygon, etc.)

The arrangement of the conductive scattering elements in concentric circles and squares is by way of example and is not limiting. For example, a lens having axial symmetry may be advantageous, in which case the conductive scattering elements may be arranged in concentric groups having any regular polygonal form. In other embodiments, a lens may be required to focus energy in a single plane, in which case an asymmetric or substantially linear geometry may be more appropriate.

While the above example metamaterial RF lenses are fabricated on one or more substantially planar substrates, it will be appreciated that in other embodiments the lenses may be formed on curved substrates or on a combination of planar and curved substrates.

The metamaterial RF lenses according to embodiments of the present invention may be designed using an electronic computer program providing simulation of electromagnetic waves in the presence of conductive scattering elements such as, for example CST Studio Suite or REMCOM XFdtd, which facilities for the optimization of the shape and dimensions of individual conductive scattering elements and their configuration on a dielectric lamina such as a printed circuit board substrate.

The metamaterial RF lenses according to embodiments of the present invention may be implemented on printed circuit boards in some embodiments, with each metamaterial RF lens being positioned forwardly of the radiator(s) of a respective one of the radiating elements in the one or more arrays. The metamaterial RF lenses may be thin and hence may only require a limited increase in the depth of the base station antennas in which they are used. The metamaterial RF lens according to embodiments of the present invention may focus the antenna beams emitted by an associated radiating element in both the azimuth and elevation planes, thereby increasing the directivity of the antenna beams. The metamaterial RF lens may be designed so that they introduce only a small increase in the insertion loss, and the metamaterial RF lens may exhibit good impedance matching with the radiators of the radiating elements so that the return loss may be low over a wide frequency range. Thus, the metamaterial RF lens according to embodiments of the present invention may provide increased gain reduced azimuth beamwidths, both of which are desired by cellular network operators.

Embodiments of the present invention have been described above with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

Herein, a first element overlaps a second element in a given direction (e.g., the forward direction) if an axis that extends in the direction passes through both elements.

Herein, the term “substantially” refers to variation of less than 10%, unless otherwise noted.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “on” another element, it can be directly on the other element or intervening elements may also be present. In contrast, when an element is referred to as being “directly on” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between”, “adjacent” versus “directly adjacent”, etc.).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, operations, elements, and/or components, but do not preclude the presence or addition of one or more other features, operations, elements, components, and/or groups thereof.

Aspects and elements of all of the embodiments disclosed above can be combined in any way and/or combination with aspects or elements of other embodiments to provide a plurality of additional embodiments.

1. A radio frequency (“RF”) lens, comprising:
a dielectric substrate;
a central lens element on the dielectric substrate, the central lens element comprising a first plurality of conductive elements on the dielectric substrate that are arranged to surround a central region; and
a plurality of satellite lens elements that surround the central lens element when the RF lens is viewed from the front, each satellite lens element comprising a respective second plurality of conductive elements on the dielectric substrate.

2. The RF lens of claim 1, wherein an opening extends through the dielectric substrate in the central region.

3. The RF lens of claim 1, wherein the first plurality of conductive elements are arranged in concentric circles that extend around the central region.

4. The RF lens of claim 1, wherein the satellite lens elements are radially arranged around the central lens element when the RF lens is viewed from the front.

5. The RF lens of claim 1, wherein the first plurality of conductive elements are arranged in a first pattern and at least one of the second plurality of conductive elements is arranged in a second pattern, where the second pattern matches at least a portion of the first pattern.

6. (canceled)

7. The RF lens of claim 1, wherein each satellite lens element is smaller than the central lens element.

8. The RF lens of claim 1, wherein a plurality of satellite openings extend through the dielectric substrate, the satellite openings positioned in between the central lens element and the plurality of satellite lens elements.

9. (canceled)

10. The RF lens of claim 1, wherein each satellite lens element has a truncated circular shape when viewed from the front.

11-12. (canceled)

13. A radio frequency (“RF”) lens, comprising:
a dielectric substrate;
a central lens element on the dielectric substrate, the central lens element comprising a first plurality of conductive elements on the dielectric substrate that extend outwardly from an opening through the dielectric substrate; and
a plurality of satellite lens elements that surround the central lens element when the RF lens is viewed from the front, each satellite lens element comprising a respective second plurality of conductive elements on the dielectric substrate.

14-16. (canceled)

17. The RF lens of claim 13, wherein each satellite lens element is smaller than the central lens element.

18. The RF lens of claim 13, wherein a plurality of satellite openings extend through the dielectric substrate, the satellite openings positioned in between the central lens element and the plurality of satellite lens elements.

19. The RF lens of claim 13, wherein each satellite lens element has a truncated circular shape when viewed from the front.

20-31. (canceled)

32. A radio frequency (“RF”) lens, comprising:
a dielectric substrate;
a circular central lens element on the dielectric substrate, the circular central lens element comprising a first plurality of conductive elements on the dielectric substrate; and
a plurality of satellite lens elements that surround the central lens element when the RF lens is viewed from the front, each satellite lens element comprising a respective second plurality of conductive elements on the dielectric substrate.

33. The RF lens of claim 32, wherein each satellite lens element has a shape that corresponds to at least a portion of a circle.

34. (canceled)

35. The RF lens of claim 32, wherein an opening extends through the dielectric substrate in the middle of the circular central lens element.

36-37. (canceled)

38. The RF lens of claim 32, wherein the satellite lens elements are radially arranged around the circular central lens element when the RF lens is viewed from the front.

39. The RF lens of claim 32, wherein the first plurality of conductive elements are arranged in a first pattern and each second plurality of conductive elements are arranged in a respective second pattern, where each second pattern matches at least a portion of the first pattern.

40. The RF lens of claim 32, wherein a number of satellite lens elements that surround the central lens element is four, six or eight.

41. The RF lens of claim 32, wherein each satellite lens element is smaller than the central lens element.

42. The RF lens of claim 35, wherein a plurality of additional openings extend through the dielectric substrate, the additional openings positioned in between the circular central lens element and the plurality of satellite lens elements.

43-44. (canceled)
